(19) United States
(12) Patent Application Publication
(10) Pub. No.: US 2026/0105090 A1
(43) Pub. Date: Apr. 16, 2026

(54) CONVERSATIONAL COMPUTING DEVICE ASSISTANT

(71) Applicant: GOOGLE LLC, Mountain View, CA (US)

(72) Inventors: Juan Bernardo Mejia Reyes, Seattle, WA (US); Justin Robert DeWitt, Bainbridge Island, WA (US); Dmitry Gennadievich Titov, Woodinville, WA (US); Bohdan Vlasyuk, Zurich (CH); Jonas Albin Mattias Rangefelt, Zurich (CH); Nur Deniz Ozkaraoglu, Bellevue, WA (US); Swaroop Indra Ramaswamy, Mountain View, CA (US); Morgane Charlotte Zoé Lustman, Zurich (CH); Zhitong He, Pfäffikon SZ (CH); Sergio Eduardo Collazos Iriarte, San Francisco, CA (US); Aarush Selvan, New York, NY (US); Janice An Lei Wong, San Francisco, CA (US)

(21) Appl. No.: 19/355,370

(22) Filed: Oct. 10, 2025

Related U.S. Application Data
(60) Provisional application No. 63/706,391, filed on Oct. 11, 2024.

(51) Int. Cl. G06F 16/334; G06F 9/451

(52) U.S. Cl. CPC G06F 16/334; G06F 9/451

(57) ABSTRACT

Systems and methods for a conversational assistant are disclosed. A method may include receiving a user query and determining that additional context is required. In response, environment content relevant to the query is identified and obtained. Identifying the content can involve generating an embedding of the query and comparing it to embeddings of resources previously accessed by the user, such as browser history or local files, to find resources that satisfy a similarity criterion. The user query and the obtained environment content are provided to the assistant. The assistant then provides a multi-modal output based on the combined information, where the output may include at least one action. Upon receiving the output, the action is performed. This enables the assistant to provide more relevant responses and perform tasks such as opening relevant webpages in an organized tab group, thereby streamlining the user's workflow.

### CROSS REFERENCE TO RELATED APPLICATION

This application claims the benefit of U.S. Provisional Application No. 63/706,391, filed Oct. 11, 2024, the disclosure of which is incorporated herein by reference in its entirety.

### BACKGROUND

Applications for computing devices enable users to perform tasks, such as drafting documents, editing images and videos, tracking events, and accessing remote content provided by websites. Browser applications provide access to websites, which provide information or functionality helpful to users. Many users use the Internet to research products, places, companies, services, view social media or new feeds, etc.

### SUMMARY

Implementations relate to an architecture that provides access to and interaction with a multi-modal, conversational assistant on a personal computing device. The architecture includes a tool integrated into a computing device, e.g., as an application or as a function of the operating system, that provides a user-interface for interacting with the assistant. The tool may be initiated by a dedicated control, a dedicated input combination, a dedicated audio command, etc. The tool may be referred to as a conversational assistant manager. The assistant manager may provide a user interface that enables the user to provide a prompt via a variety of input methods (text, speech-to-text, etc.). The user interface can enable the user to identify files relevant to the prompt. The tool may, in accordance with user permissions, access context for the prompt from main content and the operating environment existing when the prompt is provided. The main content represents content displayed in a window with focus when the tool is invoked. The operating environment includes screen capture events, screen sharing events (a series of screen capture events), metadata about a webpage (e.g., from the document object model or ally tree, etc.), files associated with the user and/or the user's device that are relevant to the prompt, environment variables, etc.

The architecture also includes a service that includes one or more generative models configured to take the prompt from the user and the context related to the prompt as input and provide a multi-modal output for the prompt. The multi-modal output may include conversational text. The multi-modal output may include images. The multi-modal output may include actionable output, such as links, extensions, API calls, media (images, video, audio, etc.) and the like. Thus, a multi-modal output can include output for display and/or output configured to cause a computing device to perform an action. The service may be referred to as a conversational assistant engine. The service may be provided by a server. The service may be provided on-device.

The details of one or more implementations are set forth in the accompanying drawings and the description below. Other features will be apparent from the description and drawings.

### BRIEF DESCRIPTION OF THE DRAWINGS

FIG. 1A is a diagram that illustrates initiation of a conversational assistant manager, according to at least one example implementation.

FIG. 1B illustrates an example action performed in accordance with a multi-modal output generated in response to the example prompt of FIG. 1A, according to at least one example implementation.

FIG. 2 illustrates an example user interface for a conversational assistant manager, according to at least one example implementation.

FIG. 3 is a diagram that illustrates an environment that includes a computing system and server for implementing concepts and various implementations shown and described herein.

FIG. 4 is a flowchart illustrating a method for identifying context relevant to a user query, according to at least one example implementation.

### DETAILED DESCRIPTION

Implementations of a conversational computing device assistant are described herein. Modern conversational assistants often struggle to provide relevant and helpful responses because they lack sufficient context beyond the user's immediate query and conversation history. This requires users to manually find and provide additional information from other applications or browser tabs, which is a cumbersome and inefficient process. The systems and methods described herein address this challenge by enabling an assistant to automatically determine when a query requires more context and, with user permission, identify and obtain relevant environment content from the user's device, such as browser history or local files. By providing this richer context to the assistant along with the original query, the assistant can generate more accurate, multi-modal responses that include not just text but also direct actions, such as opening relevant webpages in an organized tab group, thereby streamlining the user's workflow and significantly reducing the effort needed to accomplish complex tasks.

Conversational assistants or simply assistants, are increasingly integrated into modern computing devices to help users perform a wide range of tasks through natural language interactions. A user may interact with an assistant by providing a user query, which can be in various forms such as typed text, spoken commands, or even gestures. The assistant processes this query to understand the user's intent and generate a relevant response. Ideally, these responses are not only informative but also actionable, streamlining the user's workflow and enhancing their productivity.

However, the utility of a conversational assistant is fundamentally dependent on the context available to it. A user query, such as a simple text input, often lacks the necessary context for the assistant to provide a truly helpful or relevant response. For example, a user asking “what are the main points?” is providing an ambiguous query that is unanswerable without knowing what content the user is referring to. Moreover, providing relevant responses enhances the user experience, as irrelevant or generic answers can lead to user frustration and abandonment of the assistant. However, providing the additional context needed is often a challenging and cumbersome process for the user, requiring them to manually copy and paste information from other applications, browser tabs, or files into the assistant's interface, thereby defeating the purpose of a seamless and efficient interaction.

This limitation of conventional conversational assistants gives rise to a significant technical problem of the inability of the assistant to independently and efficiently access relevant context beyond the immediate user query and the conversational history. This technical problem manifests in several related challenges. One technical problem is the system's difficulty in determining when a user query is ambiguous or incomplete and thus requires additional context. Without this determination, the system may provide a generic, unhelpful response, forcing the user to rephrase or manually provide the missing information. Another technical problem lies in identifying and obtaining the correct additional context even if the need for it is recognized. The relevant information might be located in the user's web browser history, an open application, or a local file on the device. Conventional assistants are typically siloed from this environment content, lacking the technical means to access and reason over it.

This deficiency leads to further technical problems related to user inefficiency and the consumption of computing resources. Users wishing to perform complex tasks, such as planning a trip by comparing information from multiple websites, must manually switch between tabs, copy data, and synthesize information themselves before presenting a query to the assistant. Each of these user-driven steps such as navigating between windows, and opening files, copying and pasting content, involves multiple user interactions, consumes valuable processing cycles, increases memory usage, and unnecessarily depletes system resources like battery power on mobile devices. This multi-step process results in a fragmented and inefficient workflow, causing user frustration and diminishing the perceived value of the assistant. The technical problem, therefore, is not merely one of inconvenience but of significant computational and human-computer interaction inefficiency. Existing interfaces for conversational models are limited, as they fail to account for other user activity on the computing device, requiring manual intervention that interrupts workflow and wastes resources.

At least another technical problem with existing conversational assistants is that a user may have questions about a content but may not want to leave the content, either by opening a new window (including a new tab in a browser window) or by navigating away from the resource, to find answers. At least another technical problem is that when the user leaves the main content (e.g., by opening a new tab or otherwise navigating away from the content), context that might assist the user in identifying additional information that answers the question is lost. Another technical problem with existing conversational models is that the models provide only text (including text-to-speech) as output. This limits the usefulness of responses and does not allow the assistant to help the user beyond providing written (or audible) instructions.

To overcome these significant technical problems, a novel technical solution is required that fundamentally changes how a conversational assistant interacts with the user's computing environment. Conventional solutions have fallen short. For instance, some assistants operate in isolated web pages or applications, completely divorced from the user's broader activities. Other approaches might allow users to manually share a link or a piece of text with an assistant, but this still relies on explicit, burdensome user actions for every piece of context. These conventional methods fail to automate the process of context gathering, placing the entire burden of bridging the context gap on the user. They lack an intelligent mechanism to proactively identify the need for more information and to automatically source that information from the user's environment in a secure and permission-based manner.

The technical solution presented herein addresses these technical problems by providing a system and method where a conversational assistant can determine that additional context is required to satisfy a user query and, in response, identify and obtain relevant environment content from the user's device. This technical solution involves integrating an assistant manager directly into the computing device's operating system or browser application. When a user provides a query, the system first determines if the query is sufficiently specific. If not, the assistant manager, with user permission, identifies relevant environment content. This identification can be achieved by, for example, generating a semantic embedding of the user query and comparing it against embeddings that correspond to resources the user has previously accessed, such as their browser history or locally stored files. Resources that satisfy a similarity criterion may be identified as relevant context.

Once relevant environment content, such as Uniform Resource Locators (URLs) of previously visited webpages or the content of local documents, is identified, it is obtained and provided to the assistant's underlying generative model along with the original user query. This enriched input allows the generative model to produce a much more accurate, relevant, and helpful multi-modal output. This technical solution enables the assistant to move beyond simple text-based answers. The output can include actionable components, such as generating Application Programming Interface calls (API calls) to a browser application. For instance, the assistant can be instructed to open the identified relevant URLs in new browser tabs and even organize them into a cohesive tab group, directly advancing the user's task without requiring further manual intervention.

Implementations also provide at least one technical solution by providing an on-device assistant manager that, with user permission, can access main content, environment content related to the main content, and/or information associated with the user and/or the user device to provide richer context for a prompt. Implementations may extract at least some content from the main content. The extracted content may be used to provide context for the prompt, enabling the user to refer to items in the main content without having to fully describe the items. Main content is content for a resource, e.g., a webpage, a document, an image, an application window, etc. Main content can be associated with a location (e.g., a URL) and a content provider. Main content can be associated with an application. The main content includes content visible to the user, e.g., in an application window, such as the viewport of a browser. Main content can be provided from a screen capture or a series of screen captures. Screen captures include images of the display of the user device and/or information from display buffers.

Implementations may extract or identify at least some content related to the prompt that is not main content. This content is referred to as environment content. Environment content includes content of the resource not visible in the application window, which may include tabs in a browser window that do not have focus, content in application windows hidden behind the main content, content of a resource not currently “above the fold”, etc. Environment content can include environment variables, which can describe aspects of the operating environment, such as the number of executing applications, identification of installed applications or extensions, available resources, etc. Environment content can include information used to render a resource in a browser, such as information in the document object model (DOM) or ally tree. An ally tree includes information that supports browser tools for users with visual impairment. Environment content can include, with user permission, information related to files associated with the user and/or the user device and/or resources visited by the user, e.g., via a browser. With user permission, these files can have an encoded file summary that represents a semantic embedding of the file. In some implementations, the encoded file summaries can be used to determine whether a resource relates to (is similar to) a user prompt and, if so, content from the file may be included as environment content. This enables the assistant to identify relevant information and potentially act on such information. Any environment content that the assistant manager determines is related to the prompt may be extracted and provided to the conversational assistant engine as expanded prompt context.

The assistant manager can also provide a user interface that enables a user to identify content (e.g., a website or other file) the user would like to provide as context for the prompt without having to navigate away from the main content. In other words, the user interface supported by the assistant manager may enable a user to attach a file to be used as prompt context. The expanded context, which includes main content and environment content enables the user to ask questions and converse with the assistant about what is on the user's screen. This can be a major benefit for users with vision impairment because the assistant can answer questions about the main content in natural language responses, providing a much more natural interaction with the main content than conventional screen readers and other such tools. The expanded context also enables the users to provide more succinct prompts because the user no longer needs to describe/provide context for the prompt.

Another technical solution provided by disclosed implementations is the expansion of model output modalities. Implementations may use multiple generative models or specially trained models to not only provide text output, but also to provide media, summaries, comparisons (including in tabular format), and actionable responses. The actionable responses can include API calls, extensions to start, webpages to open, etc. The multi-modal responses can greatly reduce and simplify the human-machine interactions needed to accomplish a task, reducing use of computing and human resources.

The implementation of the disclosed implementations yields several advantageous technical effects, significantly improving the functionality of the computing device and the user's interaction with it. One key technical effect is the substantial reduction in the number of user interactions required to complete complex tasks. By automatically identifying and incorporating context, the system streamlines the user's workflow, transforming a multi-step manual process into a single conversational command. This leads to a more efficient and less frustrating user experience. A related technical effect is the conservation of computing resources. By automating the context-gathering process, the system reduces redundant processing cycles, memory usage, and network bandwidth that would otherwise be consumed by the user manually navigating between applications and web pages. This optimization is particularly beneficial for battery-powered devices.

Furthermore, another technical effect is the enhancement of the assistant's capabilities, allowing it to generate sophisticated, multi-modal outputs that include direct actions within the operating environment. Instead of simply providing information, the assistant becomes an active participant in completing the user's task, for example, by organizing research materials into a tab group or adding an event to a calendar based on information found in a relevant webpage. This elevates the assistant from a passive information retriever to a proactive productivity tool. The overall technical effect is a more intelligent, integrated, and efficient human-computer interface that more closely mimics a truly helpful assistant, one that understands not just what the user says, but also the broader context of what they are doing.

Another technical benefit provided by the conversational assistant manager is that the tool aids users in finding the right information by making it easier to dive deeper and find answers via content understanding that goes beyond just the main content (e.g., the content with focus). Put another way, the disclosed architecture combines multiple functionalities in one place and uses intelligent understanding of the text and/or images in main content and related environment content to help a user answer questions, understand content, and perform tasks. The content of a resource is maintained (e.g., persists) while the conversational assistant manager user interface is displayed. Put another way, the user interface provided by the conversational assistant manager may be configured to have a small footprint, allowing the main content to be maintained while the user interacts with the assistant. At least one technical effect of the disclosed architecture is a reduction in the number of interactions a user has with the computing device to discover new information, solve problems, and accomplish tasks.

Implementations include a content extractor that is configured to capture main content and/or environment content. For example, the content extractor may be configured to scrape the main content, e.g., by examining the document object model (DOM) tree for the main content and/or the accessibility tree (Ally tree) for the main content. The prompt context includes text represented in the main content. The prompt content can include text and/or images represented in the main content.

As another example, the content extractor may be configured to obtain a screen capture of the display, or in other words, perform a screen capture event. In some implementations, the screen capture may be an image and the content extractor may be configured to perform recognition on the image. The recognition can include text recognition. The recognition can include entity recognition. In some implementations, no recognition is performed on the screen capture and the screen capture is provided to the conversational assistant engine as obtained. In such implementations, a generative model may perform recognition on the screen capture as part of processing the model input. In some implementations, the screen capture may be obtained via a display buffer.

In some implementations, the content extractor may be configured to capture multiple screens, e.g., perform multiple screen capture events in succession and/or to do a video screen capture. This may be to effect screen sharing, so that the environment content can include transformations of the screen content as prompt context.

In some implementations, and with user permission, the content extractor may be configured to search for and identify environment content that is relevant to a user query provided by the user. In some implementations, the content extractor may use encoded file summaries to identify files relevant to the prompt. The encoded file summaries may be semantic embeddings generated from the content of the files. A similarity measure between the semantic embedding for a file and a semantic embedding for the prompt may be used to determine whether that particular file is relevant to the prompt. Once identified, the content of the file and/or an identifier of the file may be included in the environment content. The encoded file summaries may represent files stored on the user's device. The encoded file summaries may represent websites (webpages) visited by the user. The encoded file summaries may represent files associated with a user profile, such as files stored in a cloud account tied to the user profile.

The prompt context may thus represent at least some content extracted from the main content and may also include some environment content. In some implementations, the content extractor can be a machine-learned extraction model. The content extractor can be configured to exclude certain types of information from the main content and the environment content. For example, excluded content may include user information, sensitive information, third-party information (e.g., content supplied by an entity that is not the content provider, such as ads), etc. For example, the extraction model can be trained to recognize and exclude user information, sensitive information, third-party information, etc.

Implementations include a conversational assistant engine, which includes at least one generative model. The conversational assistant engine may be configured to receive multi-modal input and provide multi-modal output. The multi-modal input is a prompt which includes user query and the prompt context. Either or both of the user query or the prompt context may include text, text and media (images, video, audio), text and file identifiers (e.g., URLs), or text and media and file identifiers. The conversational assistant engine may use one or more generative models to generate the output. A generative model is a model based on a transformer architecture that can generate realistic text and/or image responses to a prompt. Such models generally have a very large number of parameters. In some implementations, the generative model may be a specially trained generative model. Such a model may have been provided with a golden or silver dataset to teach it how to generate multi-modal responses. A golden dataset is a refined collection of data that serves as a source of truth for the model. A silver dataset may include less refined data that is still sufficient for training the model. In some implementations, the conversational assistant engine may include multiple generative models. In such an implementation, a first generative model may generate an output of one type of modality and a second model may generate an output of a different modality. In some such configurations, the output of the first model may be used as input into the second model. The output of both models may be used to provide the multi-modal output. Implementations are not limited to just two models; a third or fourth model may also be included, which each provide output of a different modality than the first or second model and may take the output of the first or second model as input. In some implementations, the conversational assistant engine may be configured to evaluate how well the output (the generated response) from the first model responds to the query. If the output does not meet a threshold, the conversational assistant engine may be configured to provide the prompt to another generative model to supplement the output of the first model. The conversational assistant engine may provide the generated response (from the one or more generative models) to the assistant manager. The assistant manager may display the text and media portion of the response in the user interface and may implement any actions represented in the response. The actions may include API calls, initiating (launching) extensions, generating a comparison or summary interface, opening web pages, etc.

The applications described herein can be executed within a computing device. For example, the applications can be executed within a laptop device or desktop computing device. In some implementations, the browsers can be executed within a mobile device or on any other device with limited screen space (a limited display area). Although many of the implementations shown and described herein are shown in landscape mode, any of the implementations described herein can be rendered in portrait mode. Likewise, implementations described herein in portrait mode can be rendered in landscape mode.

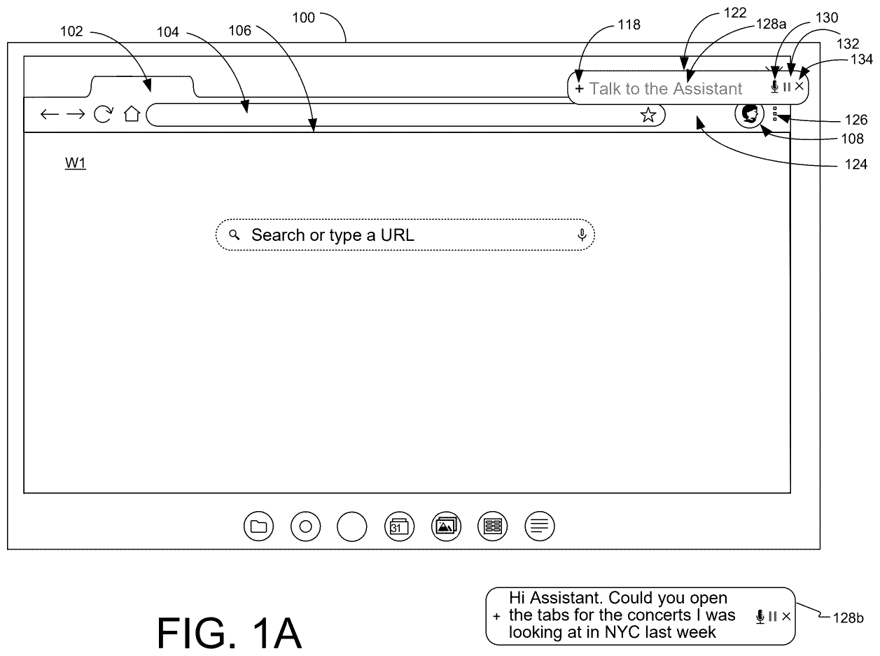

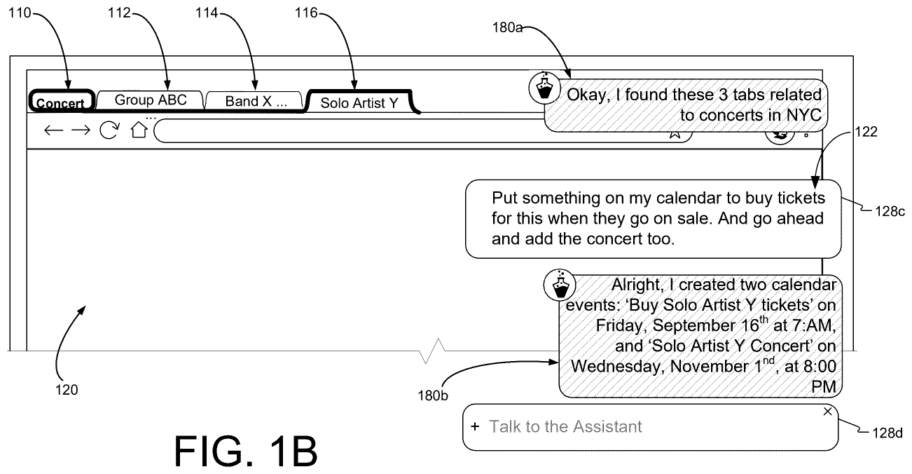

FIG. 1A is a diagram that illustrates initiation of a conversational assistant manager, according to an implementation. FIG. 1A is a diagram that illustrates a browser 100 displaying a resource W1 within a display area 106 of the browser 100. The browser 100 is one example of an application executing on the computing device and implementations are not limited to main content in a display area 106 of the browser 100. In some implementations, the display area 106 can be within a tab 102 of the browser 100. The browser 100 includes an address bar area 124. An address (location) of the webpage W1 can be displayed in the address bar area 124 (e.g., input address area 104). The address bar area may include a user icon 108 representing a profile of a user associated with the browser window. Other controls, icons, and/or so forth can be included in the address bar area 124. The address bar area 124 can be controlled by and/or associated with the browser 100 (e.g., the browser application). Because the address bar area 124 is controlled by the browser 100, the webpage W1 and/or a provider of the webpage W1 may not have access to content displayed in the address bar area 124 or triggering actions provided by actionable elements of the address bar area 124.

In some implementations, the computing environment may provide tool icon (not shown). The tool icon may be a selectable control configured to open and display the assistant user interface (UI) 122 for interacting with the assistant manager. In some implementations, the assistant manager is a function of the operating system. In some implementations, the assistant manager is an application executed by the operating system. In some implementations, the assistant manager is part of an operating system that also operates as the browser 100. In some implementations, the tool icon can be a floating icon. In some implementations, the tool icon can be displayed in the title bar of the browser 100 window. In some implementations where the assistant manager is integrated with (e.g., is a function of the operating system that operates as the browser 100) or specifically supported by the browser 100, the tool icon may be placed in the address bar area 124, including in the input address area 104. In some implementations (not shown) the tool icon can be placed in a taskbar or shelf of the operating system.

In response to selection of the tool icon, the assistant manager is configured to display an assistant user interface such as the assistant UI 122. In some implementations (not shown), the assistant UI 122 can be triggered in response to a dedicated input combination. The input combination can be a gesture or a combination of gestures. The input combination can be a keyboard key or a combination of keyboard keys. The input combination can be a specific device configuration (e.g., opening a foldable device). The input combination can be a combination of a gesture and a keyboard key. The input combination can be a spoken wake word. In some implementations, the triggering of the assistant UI 122 may be via selection of a menu option. In some implementations, the menu option may be a menu option in a menu displayed in response to selection of more options icon 126. In some implementations, the menu may be a menu displayed in response to a menu input, such as right-clicking or long-pressing in the display.

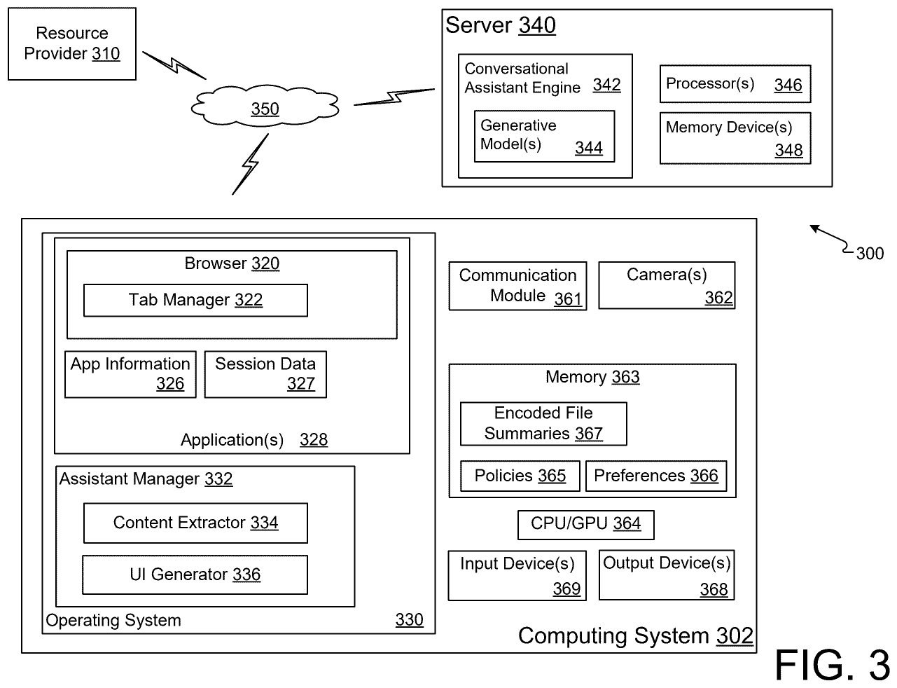

The assistant UI 122 can be a minimal UI so that it minimizes the amount of screen space it occupies. Accordingly, the minimal UI enables the user to still view the main content, i.e., the majority of the display. In some implementations, the assistant UI 122 includes a file attachment control 118. The file attachment control 118 may be a selectable control configured to, in response to being selected, allow the assistant UI 122 to accept a file for inclusion in the prompt and/or prompt context, as discussed in more detail with respect to FIG. 3. In some implementations, the assistant UI 122 includes user query area 128a. The user query area 128a is configured to receive text from the user. In some implementations, the user can type in the user query area 128a. In some implementations, the user can use a stylus to write in the user query area 128a. In some implementations, the user can select an audio input control 130 to provide speech-to-text input into the user query area 128a. In some implementations, the assistant UI 122 can include a pause control 132. The pause control 132 is a selectable control configured to, in response to selection, cancel a current prompt request. A prompt request includes the current prompt (e.g., user query from user query area 128a) and prompt context. Because generating a response to the prompt request is resource intensive, the response generation has a latency period, i.e., the period between when the prompt request is submitted and when the response is returned. The pause control 132 may be used to cancel the current prompt request during this latency period.

The assistant UI 122 may include a close control 134. The close control may be a selectable control configured to, in response to selection, remove (clear) the assistant UI 122 from the display. Selection of the close control 134 will also cancel the current prompt request. In some implementations, the assistant UI 122 may include a menu control (not shown). The menu control may be a selectable control configured to, in response to selection, provide a menu enabling the user to configure the assistant manager, among other things. Some example configuration options for the assistant manager can include, but are not limited to, preferred voice style, preferred mode of input and output (voice or text), disabling of the assistant entirely, or controlling specifics of the UI for ease of use. Implementations may also include other controls (not illustrated), such as a control configured to open a conversation history user interface. The conversation history user interface may be a different UI (e.g., separate from the assistant UI 122) for reviewing and controlling the assistant's record of past interactions.

In some implementations, the assistant manager may begin obtaining prompt context before and/or while the user is providing input to the user query area 128a. For example, the assistant manager may begin obtaining main content from the resource W1, including text and/or information about one or more images. As another example, the assistant manager may begin obtaining environment context from, for example, metadata associated with the resource W1 (such as the DOM or Ally tree). In some implementations, the environment content is identified by analyzing the document object model (DOM) for the main content. In some implementations, the environment content is identified by analyzing an accessibility tree for the main content. In some implementations, the environment content is identified by analyzing the DOM and the accessibility tree for the main content. A benefit of using both a DOM tree and an accessibility tree is additional descriptive nodes in the accessibility tree for DOM elements such as images. In some implementations, the environment content is non-third-party content. For example, advertisement content may be excluded from the environment content.

In some implementations, user input is excluded from the environment content. For example, if the main content includes any input controls (e.g., text boxes, drop-down boxes, etc.) the content associated with the input controls may be excluded from main content. In some implementations, sensitive content may be excluded from environment content. For example, content that is adult content or content related to financial information (e.g., a website listing bank account information) may be excluded from environment content. In some implementations, user content may be excluded from environment content. For example, user birthdates, names, identifiers, etc. may be excluded from environment content. In some implementations, a machine-learned model may be used to identify the environment content. For example, a DOM and/or an accessibility tree may be provided to the model and the model may determine the environment content. The model is a model that runs on the client device. Thus, environment content is determined on the client device. Another example of environment content that may be obtained is content related to open tabs and the resources associated with the open tabs. Other environment content may also be obtained.

In some implementations, additional environment content may be obtained once the user has entered the user query in the user query area 128a or submitted the prompt. Prompt submission may be signaled by a predetermined input, such as pressing an enter key. An example of additional environment content obtained after the prompt submission includes files that relate to the user query. This may be done by converting the user query into the embedding space used for the semantic embedding of the files. The semantic embedding of the user query is then compared with the semantic embeddings of the files to determine which files, if any, are sufficiently relevant to (meet a similarity criterion with) the prompt. In some implementations, identifiers for these relevant files are added to the environment context. In some implementations, at least a portion of the content from the files is added to the environment context.

In the example of FIG. 1A, the user may provide the user query “Hi Assistant. Could you open the tabs for the concerts I was looking at in NYC last week” into the user query area of the 128a, e.g., as illustrated in user query area 128b. Submission of this user query may cause the assistant manager to obtain additional prompt context so that the generative model can understand the prompt. For example, the assistant manager may include a pre-processing function that is configured to determine whether additional context is required to satisfy the prompt. The pre-processing function can include a generative model configured to perform this function. In the example of FIG. 1A, the assistant manager determines that the user query references additional context and as such determines that additional context may be needed for properly responding to the user query. When it is determined that additional context is needed, in one example, the assistant manager may generate a semantic embedding of the user query and compare that embedding with semantic embeddings representing browser history visits. A browser history visit is a resource that the user has visited using the browser in the past. In some implementations, only browser history visits that meet a recency criterion (e.g., recency threshold) may be stored as semantic embeddings.

The semantic embedding may have been created, with user permission, when the user last visited the resource. The semantic embedding is a representation of the content of the resource and converting that content into the semantic embedding spaces enables the computing device to store a representation of the content in a much more memory efficient manner than storing a copy of (e.g., cached version of) the resource. It also allows for very fast similarity comparisons. In the particular example of FIG. 1A, page visits most relevant to “concert” and “New York City” will be identified. In some implementations, the identifiers for these web pages will be provided as environment content in the prompt context. The prompt context and the user query are provided as input to the generative model that is part of the conversational assistant engine. The conversational assistant engine may be a service provided by a server, such as server 340 of FIG. 3. In some implementations, the conversational assistant engine may be local to the computing device, such as computing system 302 of FIG. 3.

FIG. 1B illustrates an example action performed in accordance with a multi-modal output generated in response to the example prompt of FIG. 1A, according to an implementation. In the example of FIG. 1B, the assistant UI includes response area 180a. Response area 180a includes the text portion of the response generated for the user query and prompt context by the conversational assistant engine. The text portion describes an action taken by the assistant manager. The action taken was also included in the model's response, but was not a textual mode. Instead, the action may be represented by API calls to browser functions. In particular, the browser functions may relate to adding resources (webpages) to a tab group (represented by tab group identifier 110), and opening each resource in a separate tab, each tab being associated with the tab group. Accordingly, the assistant manager changes the main content by replacing the new tab page of FIG. 1A with the three tabs 112, 114, 116 of FIG. 1B. Tab 112 represents content associated with a webpage for Group ABC, tab 114 represents content associated with a webpage for Band X, and tab 116 represents content associated with a webpage for Solo Artist Y. The webpage for Band X, the webpage for Group ABC, and the webpage for Solo Artist Y were identified as relevant to the user query entered in the user query area 128b of FIG. 1A and provided as prompt context. This enabled the generative model(s) to correctly format a call to the browser functions that open resources in a new tab and to automatically group the tabs into a new tab group. The generative model is also able to name the tab group based on the user query and prompt context.

Before closing the assistant UI, the user may provide a follow-on prompt in the user query area 128c of the assistant UI. This prompt requests that the assistant perform two specific actions related to a calendar application. Because the content associated with the webpage for Solo Artist Y is the main content (because the tab 116 is the active tab), the main content included in the prompt context allows the generative model to resolve this to the concert for Solo Artist Y and generate actions that call an API for the calendar app that adds the event to the calendar app. As depicted, the user query area 128c overlays the main content area of the browser, thus allowing the main content to remain visible during the interaction with the assistant.

Although the example of FIG. 1B illustrates an assistant UI that includes historical prompt responses (e.g., response area 180a) and user query area 128c (e.g., as part of assistant UI 122) along with the most recent prompt response (e.g., response area 180b) and user query area 128d, implementations are not so limited. In some implementations, each new response may replace the prior response in the display and the empty user query area 128d may replace a user query that has had a response returned.

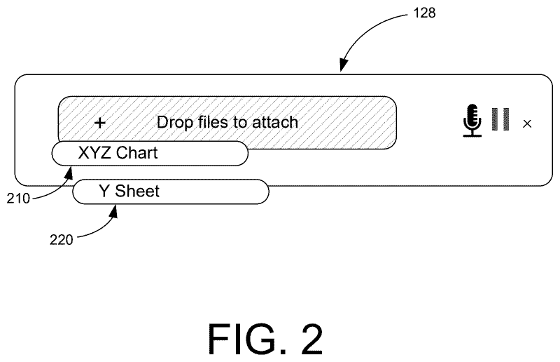

FIG. 2 illustrates an example user interface for a conversational assistant manager, according to an implementation. The example assistant UI of FIG. 2 is an example of an assistant UI 128 that accepts a file (or files) for inclusion in the prompt and/or prompt context. For example, the assistant UI 128 may configure the prompt area to be a drop target. The drop area is configured to accept the subject of a drop operation. In the example of FIG. 2, the representation 210 of a first file and representation 220 of a second file are subjects of a drag-and-drop operation and the prompt area may accept the representations dropped there. Accepting the representations can include adding the file identifiers (locations) to the prompt context. Accepting the representations may also include obtaining content from the files (all content or a portion of content) and including the content in the prompt or prompt context.

FIG. 3 is a diagram that illustrates an environment 300 that includes a computing system 302 and server 340 for implementing the concepts and various implementations shown and described herein. The computing system 302 may be a computing device with a limited screen size, such as a smartphone, a smart watch, a smart head word device (e.g., AR, VR, XR glasses), a tablet, etc. The computing system 302 may also be a computing device with a larger screen size, such as a desktop computer, a laptop, a netbook, a notebook, a tablet, a smart TV, a game console, etc., that runs a browser. In general, the computing system 302 can represent any computing device that executes applications, including a browser. As shown in FIG. 3, the computing system 302 is configured to communicate with the server 340 and/or a resource provider 310 (e.g., a web server) via a network 350.

The computing system 302 includes several hardware components including a communication module 361, one or more cameras 362, a memory 363, a central processing unit (CPU) and a graphics processing unit (GPU) 364, one or more input devices 369 (e.g., touch screen, mouse, stylus, microphone, keyboard, etc.), and one or more output devices 368 (screen, speaker, vibrator, light emitter, etc.). The hardware components can be used to facilitate operation of the browser 320, the assistant manager 332, applications 328, the operating system 330, and/or so forth of the computing system 302.

The computing system 302 includes at least an assistant manager 332, applications 328, and a browser 320. In some implementations, the browser 320 is integrated into (part of) the operating system 330. In other words, the operating system 330 may also be (perform the functions of) the browser 320. In some implementations, the browser 320 is configured to manage resource content, such as webpage content, provided by the resource provider 310 (e.g., a web server). In some implementations, the browser 320 is configured to operate as one of several applications 328 executed via an operating system 330. The browser 320 can be configured to generate and/or manage content rendering associated with a resource (e.g., webpage W1) in the display area 120, shown in the figures. The resource content can be provided to the computing system 302 by the resource provider 310.

The assistant manager 332 is configured to implement portions of the user interface described with respect to FIGS. 1A, 1B, and 2. For example, the assistant manager 332 may include a UI generator 336 configured to provide and support the functions described herein. The assistant manager 332 may also include a content extractor 334. The content extractor 334 is configured to obtain prompt context (e.g., main content and environment content) as described herein. For example, the content extractor 334 may be configured to ignore or exclude certain elements from the environment content. These elements can include user information, or in other words elements provided by a user (e.g., associated with input controls), elements describing a user (e.g., usernames, profile information, account numbers, etc.), etc. These elements can include sensitive information. Sensitive information may include age-restricted content (e.g., adult content, whether text or images). Sensitive information may include account information (e.g., a page from a financial institution). Thus, in some implementations, there may be little environment content provided to the server 340 because the majority of the environment content is excluded by the content extractor 334 based on a type of the resource (e.g., the resource is a sensitive resource). In some implementations, the content extractor 334 may be a machine-learned model that executes on the computing system 302. The model may be trained to detect the sensitivity of a resource. The model may be trained to determine what to extract based on the sensitivity. The model may be trained to exclude (e.g., ignore) certain types of information, such as user information and/or sensitive information.

The assistant manager 332 can also be configured to determine when to trigger display of the assistant UI 128. Put another way, the assistant manager 332 can be configured to determine what events trigger rendering of the assistant UI 128 and whether the triggering event has occurred. Triggering events can include any of those discussed herein, such as selection of a tool icon, selection of an action from a menu of actions, receipt of a dedicated input, such as voice command, key, gesture, combination of these, etc.

As shown in FIG. 3, session data 327 (which can be stored in memory 363 (not shown)) can be managed as, or by, one of the applications 328. The session data 327 can include data related to one or more browser sessions. The application information 326 can include information related to the various applications operating within and/or that can be executed by the operating system 330.

The browser 320 includes a tab manager 322 configured to generate and/or manage the various tabs (e.g., tab 112) of a browser such as browser 100. The tab manager 322 may provide entry points (e.g., APIs) for managing tabs. Providing entry points enables these functions to be available to call from the operating system 330 and/or the assistant manager 332. A generative model (such as generative model(s) 344) can be trained to output a call to one of the entry points to accomplish a given task, such as reopening a tab with content related to a webpage visited in the past.

As shown in FIG. 3, the communication module 361 can be configured to facilitate communication with the resource provider 310 and/or server 340 via the network 350 via one or more communication protocols. The camera 362 can be used for capturing one or more images, the memory 363 can be used for storing information associated with the browser 320 and/or assistant manager 332, applications 328, operating system 330, etc. The CPU/GPU 364 can be used for processing information and/or images associated with the browser 320, applications 328, and/or assistant manager 332. The computing system 302 also includes one or more output devices 368 such as communication ports, speakers, displays, and/or so forth. The functionality described in this application can be implemented based on one or more policies 365 and/or preferences 366 stored in the memory 363. In some implementations, the memory 363 is configured to store encoded file summaries 367. The encoded file summaries 367 represent semantic embeddings of files. A semantic embedding captures the main ideas and concepts contained in the content of a file in a smaller memory footprint. The semantic embeddings (encoded file summaries 367) may be for local files (e.g., files stored in the memory 363 and used by one or more of the applications 328). The semantic embeddings may be for webpages visited. The policies 365 and/or preferences 366 may provide an indication of whether or not the user has granted permission for the computing system 302 (e.g., the operating system 330 and/or the browser 320) to generate the encoded file summaries 367.

FIG. 3 illustrates some aspects of the server 340. For example, the server 340 includes one or more processors 346 (i.e., a processor formed in a substrate) and one or more memory devices 348. The server 340 includes a conversational assistant engine 342 configured to receive a request for a response to a user query and prompt context. The request comes from a client device, such as computing system 302. The conversational assistant engine 342 may be configured to accept the request (the user query and prompt context obtained by the assistant manager 332) and coordinate the generation of a response to the prompt using one or more generative models 344.

The conversational assistant engine 342 may include one or more generative models 344. The model(s) 344 may include one or more language models. Such generative language models can generate natural language responses to prompts, such as user queries entered into a prompt area of the assistant UI. In some implementations, the generative models 344 may include a language model trained to provide multi-modal output. The model may be trained with golden datasets to produce responses that include media and/or actions in addition to text in response to a prompt. In some implementations, the generative models 344 may include or have access to several different models. The several different models may have different output modalities. In some implementations, the output of one model may be used as input to a next model. In some implementations, the conversational assistant engine 342 may evaluate the text output of a generative model to determine whether additional output would improve the response. Thus, for example the conversational assistant engine 342 may determine that actions need to be generated for the prompt represented in the user query area 128c of assistant UI 122 of FIG. 1B because a text-only response did not accurately address the prompt. The generated response may be a sentence or a few sentences. Although illustrated as part of the server 340, in some implementations, one or more components of the conversational assistant engine 342 may be implemented at the computing system 302.

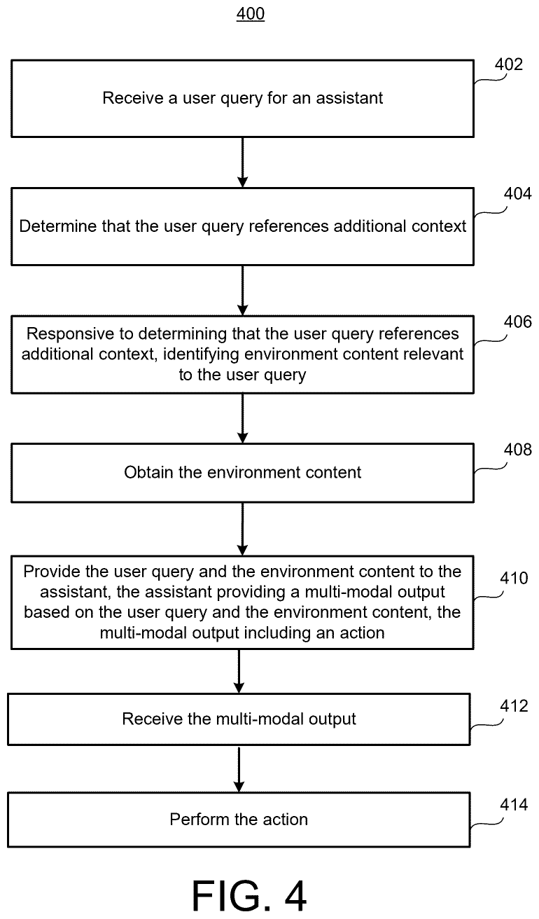

FIG. 4 is a flowchart illustrating a method for identifying context relevant to a user query, according to at least one example implementation. In some implementations, process may be performed by a computing device, such as the computing system 302 and/or server of FIG. 3. Although the process 400 of FIG. 4 is explained with respect to the computing system 302 and server 340 of FIG. 3, the process 400 may be applicable to any of the implementations discussed herein. Although process 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion.

Process 400 may begin by receiving a user query for an assistant, at step 402. The assistant may be a conversation assistant, and the user query may include text and/or other types of input. After receiving the user query, process 400 proceeds to determine that the user query references additional context (e.g., additional context is required to satisfy the user query), at step 404. This may be done by using a model.

When it is determined that the user query references additional context, process 400 proceeds to identify environment content relevant to the user query, at step 406. Identifying the environment content may include generating an embedding of the user query and then comparing the embedding to a plurality of embeddings that correspond to one or more resources previously accessed by a user and represent contents of the resources. A resource is then identified from the plurality of resources based on the comparison, when the resource satisfies a similarity criterion with the user query. The plurality of embeddings may correspond to a browser history of the user and/or a plurality of files stored on a computing device of the user.

After the environment content is identified, process 400 obtains the environment content, at step 408. This may be done by using a content extractor. The obtained environment content is then provided along with the user query to the assistant, at step 410. The assistant may provide a multi-modal output based on the user query and the environment content where the multi-modal output includes an action. Process 400 then receives the multi-modal output, at step 412 before performing the action, at step 414.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system (e.g., computer-implemented methods) including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” or “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Further to the descriptions above, a user may be provided with controls allowing the user to make an election as to both if and when systems, programs or features described herein may enable collection of user information (e.g., information about a user's browsing history, user's files, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

To provide for interaction with a user, the systems and techniques described herein can be implemented on a computer having a display device (e.g., a CRT (cathode ray tube), LED (light emitting diode), or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

In one aspect, a method is disclosed which comprises receiving a user query for an assistant, determining that the user query references additional context, and responsive to this determination, identifying environment content relevant to the user query. The method further includes obtaining the environment content and providing the user query and the environment content to the assistant. The assistant then provides a multi-modal output based on the user query and the environment content, where the multi-modal output includes at least one action. The method concludes with receiving the output and performing the action.

In another aspect, the method's step of identifying the environment content includes generating a first embedding of the user query and comparing the first embedding to a plurality of second embeddings. A second embedding in the plurality corresponds to a resource previously accessed by a user and represents the content of that resource. Based on the comparison, one or more resources from the plurality of resources that satisfy a similarity criteria with the user query are identified.

In another aspect, at least one of the plurality of second embeddings corresponds to a browser history of the user.

In another aspect, at least one of the plurality of second embeddings corresponds to a file stored on a computing device used to receive the user query.

In another aspect, obtaining the environment content includes obtaining information associated with the resource.

In another aspect, the information includes one or more uniform resource locators (URLs) for the resource.

In another aspect, the multi-modal output includes at least one actionable output comprising an application programming interface (API) call to a browser application to open the URL for the resource in a new browser tab.

In another aspect, the API call further causes the browser application to group one or more new browser tabs into a tab group.

In another aspect, main content is obtained and provided to the assistant along with the identified environment content.

In another aspect, the user query is received via a user interface that overlays a main content, allowing the main content to remain visible during the interaction.

In one aspect, a computing device is disclosed, comprising a processor and a non-transitory computer-readable medium storing instructions. When executed by the processor, these instructions cause the computing device to perform a method. The method comprises receiving a user query for an assistant, determining that the user query references additional context, and in response, identifying environment content relevant to the user query. The method further includes obtaining the environment content, providing the user query and the environment content to the assistant, which in turn provides a multi-modal output including an action. Finally, the method involves receiving the multi-modal output and performing the action.

In another aspect, the step of identifying the environment content on the computing device includes generating a first embedding of the user query and comparing it to a plurality of second embeddings. Each second embedding corresponds to a resource previously accessed by a user and represents its content. Based on the comparison, a resource that satisfies a similarity criteria with the user query is identified.

In one aspect, a non-transitory computer-readable medium is disclosed, storing instructions that, when executed by a processor, cause a computing device to perform a method. The method comprises receiving a user query for an assistant and determining that the user query references additional context. In response, environment content relevant to the user query is identified by generating a first embedding of the query, comparing it to a plurality of second embeddings corresponding to previously accessed resources, and identifying one or more resources that satisfy a similarity criterion. The method continues by obtaining the environment content, which comprises a uniform resource locator (URL) for the one or more resources. The user query and the environment content are then provided to the assistant, which provides a multi-modal output including an action. The method concludes with receiving the multi-modal output and performing the action.

In another aspect, the non-transitory computer-readable medium's instructions specify that at least one of the plurality of second embeddings corresponds to at least one of a browser history of the user or a file stored on the computing device.

What is claimed is:

1. A method comprising:
receiving a user query for an assistant;
determining that the user query references additional context;
responsive to determining that the user query references additional context, identifying environment content relevant to the user query;
obtaining the environment content;
providing the user query and the environment content to the assistant, the assistant providing a multi-modal output based on the user query and the environment content, the multi-modal output including an action;
receiving the multi-modal output; and
performing the action.

2. The method of claim 1, wherein identifying the environment content includes:
generating a first embedding of the user query;
comparing the first embedding to a plurality of second embeddings, wherein a second embedding of the plurality of second embeddings corresponds to a resource previously accessed by a user and represents content of the resource, the resource being one of a plurality of resources previously accessed by the user; and
identifying, based on the comparing, a resource from the plurality of resources that satisfies a similarity criterion with the user query.

3. The method of claim 2, wherein at least one of the plurality of second embeddings corresponds to a browser history of the user.

4. The method of claim 2, wherein at least one of the plurality of second embeddings corresponds to a file stored on a computing device used to receive the user query.

5. The method of claim 2, wherein obtaining the environment content includes obtaining information associated with the resource.

6. The method of claim 5, wherein the information includes a resource locator for the resource.

7. The method of claim 6, wherein the multi-modal output includes at least one actionable output comprising an application programming interface call to a browser application to open the resource locator for the resource in a new browser tab.

8. The method of claim 7, wherein the application programming interface call further causes the browser application to group one or more new browser tabs into a tab group.

9. The method of claim 1, wherein main content is obtained and provided to the assistant along with the environment content.

10. The method of claim 1, wherein the user query is received via a user interface that overlays a main content, allowing the main content to remain visible during interaction with the assistant.

11. A computing device, comprising:
a processor; and
a non-transitory computer-readable medium storing instructions that, when executed by the processor, cause the computing device to perform a method, the method comprising:
receiving a user query for an assistant;
determining that the user query references additional context;
responsive to determining that the user query references additional context, identifying environment content relevant to the user query;
obtaining the environment content;
providing the user query and the environment content to the assistant, the assistant providing a multi-modal output based on the user query and the environment content, the multi-modal output including an action;
receiving the multi-modal output; and
performing the action.

12. The computing device of claim 11, wherein identifying the environment content includes:
generating a first embedding of the user query;
comparing the first embedding to a plurality of second embeddings, wherein a second embedding of the plurality of second embeddings corresponds to a resource previously accessed by a user and represents content of the resource, the resource being one of a plurality of resources previously accessed by the user; and
identifying, based on the comparing, a resource from the plurality of resources that satisfies a similarity criterion with the user query.

13. The computing device of claim 12, wherein at least one of the plurality of second embeddings corresponds to a browser history of the user.

14. The computing device of claim 12, wherein at least one of the plurality of second embeddings corresponds to a file stored on the computing device.

15. The computing device of claim 12, wherein obtaining the environment content includes obtaining a resource locator for the resource.

16. The computing device of claim 15, wherein the multi-modal output includes at least one actionable output comprising an application programming interface call to a browser application to open the resource locator for the resource in a new browser tab.

17. The computing device of claim 16, wherein the application programming interface call further causes the browser application to group one or more new browser tabs into a tab group.

18. The computing device of claim 11, wherein main content is obtained and provided to the assistant along with the environment content.

19. A non-transitory computer-readable medium storing instructions that, when executed by a processor, cause a computing device to perform a method, the method comprising:
receiving a user query for an assistant;
determining that the user query references additional context;
responsive to determining that the user query references additional context, identifying environment content relevant to the user query by:
generating a first embedding of the user query;
comparing the first embedding to a plurality of second embeddings, wherein a second embedding of the plurality of second embeddings corresponds to a resource previously accessed by a user and represents content of the resource; and
identifying, based on the comparing, one or more resources from a plurality of resources that satisfy a similarity criterion with the user query;
obtaining the environment content, wherein the environment content comprises a uniform resource locator (URL) for the one or more resources;
providing the user query and the environment content to the assistant, the assistant providing a multi-modal output based on the user query and the environment content, the multi-modal output including an action;
receiving the multi-modal output; and
performing the action.

20. The non-transitory computer-readable medium of claim 19, wherein at least one of the plurality of second embeddings corresponds to at least one of a browser history of the user or a file stored on the computing device.
